(19) United States
(12) Patent Application Publication
(10) Pub. No.: US 2006/0184785 A1
(43) Pub. Date: Aug. 17, 2006

(54) Apparatus, system, and method for securing I/O communications between a blade and a peripheral interface device of a blade-based computer system

(76) Inventors: David Carroll Challener, Raleigh, NC (US); Daryl Carvis Cromer, Apex, NC (US); Steven Dale Goodman, Raleigh, NC (US); Howard Jeffery Locker, Cary, NC (US); Randall Scott Springfield, Chapel Hill, NC (US)

Correspondence Address: KUNZLER & ASSOCIUATES, 8 EAST BROADWAY, SUITE 600, SALT LAKE CITY, UT, 84111, US

(21) Appl. No.: 11/058,987

(22) Filed: Feb. 16, 2005

(51) Int. Cl. H04L 9/00

(52) U.S. Cl. 713/151

(57) ABSTRACT

An apparatus, system, and method are disclosed for securing I/O communications between a blade and peripheral interface device. The apparatus includes a determination module, a source security module, and a source communication module. The determination module identifies I/O data configured for transmission to a destination module configured to receive secure I/O data. The source security module encrypts the I/O data to generate secured I/O data such that subsequent decryption of the secured I/O data is restricted to a destination module. The source communication module transmits the secured I/O data over a vulnerable communication link to the destination module. The vulnerable communication link comprises a message intercept vulnerability. The destination module is configured to unencrypt the secure I/O data for a destination device such as a display device.

### BACKGROUND OF THE INVENTION

1. Field of the Invention

This invention relates to security of Input/Output (I/O) data associated with peripheral devices and more particularly relates to securing I/O communications between a blade and a peripheral interface device of a blade-based computer system.

2. Description of the Related Art

Data security is a continual issue in computer based electronic age. Industry experts are constantly working to stay steps ahead of those seeking to steal data and use that data for malicious purposes. One area that has received attention is the architecture of the personal computer (PC).

An open alliance between major manufacturers was formed to develop and propose a standard that would adopt hardware and software technologies to strengthen security at the system or platform level. The open alliance, formerly known as the Trusted Computing Platform Alliance (TCPA) (currently referred to as the Trusted Computing Group (TCG) but will be referred to herein as the TCPA), has proposed a standard including new hardware, BIOS and operating system specifications so manufacturers can provide a more trusted and secure PC platform based on common industry standards, the details of which are provided in the TCPA PC Specific Implementation Specification, 1.1 (http://www.trustedcomputinggroup.org).

Generally, PC architectures that implement the TCPA PC Specific Implementation Specification enjoy high levels of data security. Often this is due to the physical design of the systems. Most PC systems place the main components in a single chassis and connect external peripherals such as keyboards, mice, monitors or display devices to ports connected to circuit boards within the chassis. With laptops, the peripheral connections are even more integrated. These PC architectures are highly secure because the platform within the chassis is secured and the cabling connecting the chassis to the external peripherals is relatively short, typically between 3-10 feet. The ports of the chassis and cabling can be readily inspected for any signs of tampering or snooping devices that may be attached by an attacker desiring to intercept data signals passing through the cabling or on the internal buses of the and computer system. In all cases an attempt at tampering would be visually noticeable to end users. The intercepting of I/O data between a source and a destination is known herein as a “man-in-the-middle” attack.

Conversely, conventional blade architecture and specifically, a desktop blade architecture is susceptible to a “man-in-the-middle” attack. In a desktop blade computer system, the major components (i.e., main processor, memory, storage device, and I/O hardware) of the PC are combined into a single unit that can be readily inserted and removed from a rack or blade chassis. The blade chassis provides power and cooling for the blade and typically houses from five to twenty or more blades. The external peripheral devices such as keyboard, mouse, monitor or display, as well as other devices both parallel and serial such as those using a Universal Serial Bus (USB) port connect to a peripheral interface device also referred to as a user port. The user port communicates I/O data with the blade over a communication link. The communication link typically extends between rooms or even physical locations and uses one or more different communication mediums and/or communication protocols.

Due to the length and/or nature of the medium and protocol used for the communication link, a user or device programmed to capture I/O data passing over the communication link has a plurality of message intercept points or vulnerabilities available. Typically, such vulnerabilities can be exploited without any detection by end users.

By capturing the signals passing over the communication link, a malicious user can capture highly sensitive information. For example, video data passed from the blade to a display device may display information such as a user's password, user name, financial account codes, user identify codes (i.e., Social Security Number), and the like. Similar information can be captured by capturing the keystrokes entered by a user that travel from the keyboard to the blade.

Unfortunately, conventional blade systems are unable to prevent a “man-in-the-middle” attack, the I/O data passes over the communication link unprotected. From the foregoing discussion, it should be apparent that a need exists for an apparatus, system, and method for securing I/O communications between a blade and a peripheral interface device of a blade-based computer system. Beneficially, such an apparatus, system, and method would operate at high speed and selectively protect just the sensitive I/O data. The apparatus, system, and method would protect both outgoing and incoming streams of I/O data as well as permit securing of I/O data to be controlled programmatically and/or based on user input.

### SUMMARY OF THE INVENTION

The present invention has been developed in response to the present state of the art, and in particular, in response to the problems and needs in the art that have not yet been fully solved by currently available blade-based computer systems. Accordingly, the present invention has been developed to provide an apparatus, system, and method for securing I/O communications between a peripheral interface device and a blade of a blade-based computer system that overcome many or all of the above-discussed shortcomings in the art.

The apparatus is provided with a logic unit containing a plurality of components configured to functionally execute the necessary steps. These components in the described embodiments include a determination module, a source security module, and a source communication module.

The determination module identifies I/O data configured for transmission to a destination module configured to receive secure I/O data. The I/O data configured for transmission may be identifiable based on an indicator associated with the I/O data. Alternatively, the location of the I/O data in particular memory hardware or portions of memory hardware may serve as an indicator of the I/O data configured for transmission to a destination module as secure I/O data. The source security module is coupled to the determination module and is configured to encrypt the I/O data to generate secured I/O data such that subsequent decryption of the secured I/O data is restricted to the destination module. The source communication module transmits the secured I/O data over a vulnerable communication link to the destination module. The vulnerable communication link comprises a message intercept vulnerability. The message intercept vulnerability may take many forms including multiple access points, communications data accessible to more than one user, communications accessible using wireless receivers, and the like. In one embodiment, the vulnerable communication link comprises messages passing over a packetized network. The destination module is configured to unencrypt the secure I/O data for a destination device.

In one embodiment, the source security module includes a source Trusted Platform Module (TPM) configured to encrypt I/O data if the source TPM initializes into a secure state. Initialization into a secure state indicates that the platform is free from tampering and/or untrusted software or firmware. The destination module may comprise a destination TPM configured to decrypt the I/O data if the destination TPM initializes into a secure state.

The apparatus may include a determination module having a reader configured to read an identifier associated with the I/O data. The identifier may classify the I/O data as secure I/O data. The type of I/O data may be I/O data selected from the group consisting of raw video data, compressed video data, keystroke data, and non-keyed user input data. Of course other forms of I/O data may also be used in the apparatus. In addition, in response to a command, the determination module may selectively identify substantially all I/O data, a portion of I/O data, or no I/O data as secured I/O data. The command may be issued by a user, a software module, or indicated by the state of a switch, button, hardware component, or security device.

A system is also presented for securing I/O communications between a peripheral interface device and a blade of a blade-based computer system. The system includes components substantially similar to those described above in relation to different embodiments of the apparatus. In addition, the system includes a desktop blade having an I/O communication module configured to exchange I/O data with a user. The system may also include at least one peripheral device remote from the desktop blade and configured to directly present the I/O data to and receive I/O data from the user. A peripheral interface device connects the at least one peripheral device and the I/O communication module over a vulnerable communication link having a message intercept vulnerability. A first protection module in the desktop blade may selectively encrypt I/O data transmitted over the vulnerable communication link and decrypt I/O data received from the vulnerable communication link.

A method is also presented for securing I/O communications between a peripheral interface device and a blade of a blade-based computer system. The method in the disclosed embodiments substantially includes the steps necessary to carry out the functions presented above with respect to the operation of the described apparatus and system.

As used herein, the term “message intercept vulnerability” refers to any mechanical, technical, or logical means by which an unauthorized device, software module, and/or user can intercept messages or portions thereof passed over the vulnerable communication link. Those of skill in the art will recognize the variety of conventional and future technologies which may be used to exploit a message intercept vulnerability.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced with fewer or more of the specific features or advantages of a particular embodiment. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system suitable for use with the present invention;

FIG. 2 is a schematic block diagram illustrating one embodiment of an apparatus for securing I/O communications between a peripheral interface device and a blade of a blade-based computer system;

FIG. 3 is a schematic block diagram illustrating an alternative system for securing I/O communications between a peripheral interface device and a blade of a blade-based computer system;

FIG. 4 is a schematic block diagram illustrating one embodiment of a determination module configured for use in accordance with the present system, apparatus, and method;

FIG. 5 is a schematic block diagram illustrating an alternative apparatus for securing I/O communications between a peripheral interface device and a blade of a blade-based computer system; and

FIG. 6 is a schematic flow chart diagram illustrating one embodiment of a method for securing I/O communications between a peripheral interface device and a blade of a blade-based computer system.

### DETAILED DESCRIPTION OF THE INVENTION

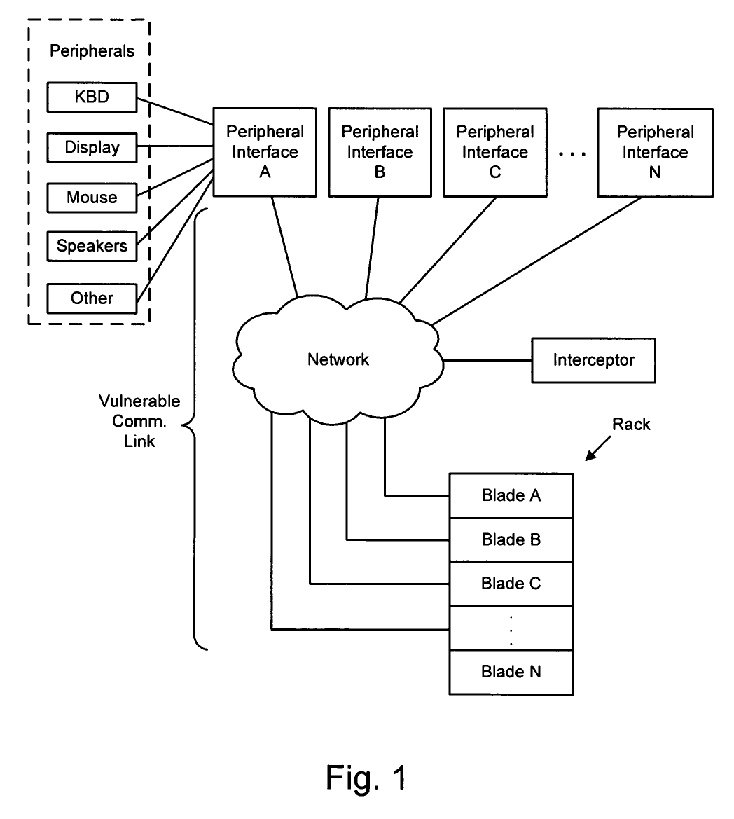

FIG. 1 illustrates a system suitable for use with the present invention. The system comprises a blade-based computer system architecture. The system includes a plurality of blades A-N housed within a common housing such as a rack. Each blade includes the main components of a computer system including a Central Processing Unit (CPU), memory, at least network communication device, and optionally a storage device such as a disk drive. The rack supplies power, ventilation, and network connectivity to the blades A-N. Of course, the blades may include wireless network components that provide network connectivity to a network.

The network connects each blade to one or more peripheral interface devices A-N. The network may comprise a conventional Local Area Network (LAN), and Wide Area Network (WAN), the Internet, and may be wired or wireless or a combination of both. The network passes I/O data between a blade and a peripheral interface device A-N.

The peripheral interface devices A-N convert I/O data from a format suitable for transmission over the network to a format suitable for use by various peripheral devices and vice versa. Preferably, I/O data traveling across the network is addressed to a particular blade A-N or peripheral interface device A-N. In addition, the peripheral interface device A-N is configured to distinguish between I/O data for particular peripheral devices such that I/O data for the display device is distinguishable from I/O data for speakers.

As used herein, “I/O data” refers to the data typically passed from hardware components of a computer system through external ports to the peripheral devices. The I/O data may include input signals as well as output signals or a combination of both depending on the capabilities of the peripheral devices. In a blade-based architecture such as the system of FIG. 1, I/O drivers in the blade employ a network interface module to pass the I/O data such as video and/or audio across the network when the peripheral interface converts the I/O data back to a format understood by the peripheral devices. Other inputs such as keyboard and mouse are passed from the peripheral interface device to the blade in a similar matter.

The peripheral devices may include a keyboard (KBD), a display device such as a monitor, a mouse, speakers, a microphone, as well as other external peripheral devices. The other external peripheral devices may be connected to conventional peripheral ports connected to the peripheral interface device. The conventional peripheral ports may include parallel, serial, Universal Serial, Bus (USB), FireWire (IEEE-1394) and the like. The conventional peripheral ports may connect peripherals such as printers, digital cameras, scanners, hard drives, flash memory storage, and the like.

Blade based computer systems such as that illustrated in FIG. 1 provide many advantages over conventional server or PC architectures. For example, blades A-N can be readily configured to operate with different peripheral interface device A-N as necessary. Hardware failure in a blade A-N can be quickly resolved by switching a user to a functioning blade and servicing all the blades in a central location.

One problem in a conventional blade-based computer system is that sensitive I/O data travels between the peripheral interface devices A-N and the blades A-N in plain text. In other words, the communication link between the peripheral interface devices A-N and the blades A-N is a vulnerable communication link. This means that a user, device, or software module with malicious intent can pose as an interceptor in communication with the network.

The interceptor is a device or software module configured to intercept I/O data passing over the network. By intercepting a sufficient amount of I/O data, the interceptor can identify sensitive information such as user names, passwords, sensitive identification numbers, and the like. In addition, the interceptor can capture information output specifically on a display device such as video data. Such video data may comprise exclusively read-only or output-only information. However, even this information is subject to interception by the interceptor. The interceptor poses a threat to the I/O data in the form of a “man-in-the-middle” attack to obtain unauthorized access to the I/O data.

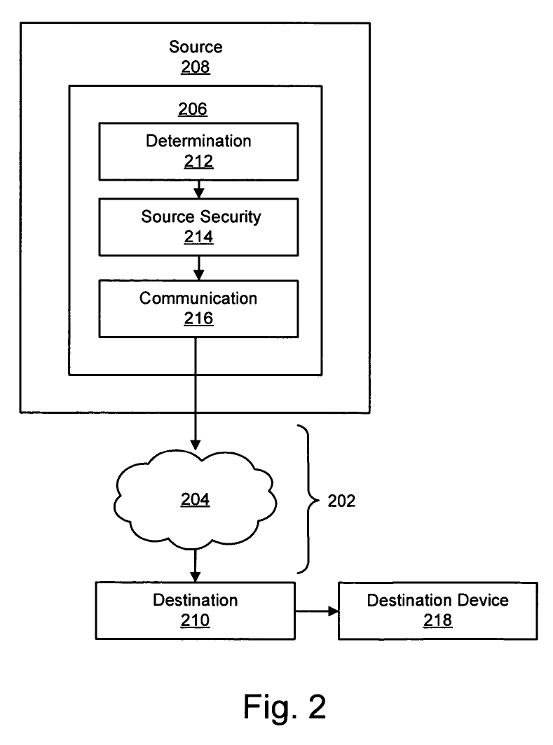

FIG. 2 illustrates a conceptual representation of components that may be used to prevent the “man-in-the-middle” attack to protect I/O data transmitted over a vulnerable communication link 202 such as a network 204. An apparatus 206, according to one embodiment, protects and secures I/O data transmitted between a source module 208 and a destination module 210. The source module 208 may comprise a blade A-N (See FIG. 1) or a peripheral interface device A-N. Similarly, the destination module 210 may comprise a blade A-N (See FIG. 1) or a peripheral interface device A-N. Preferably, the apparatus 206 is configured to both send I/O data in a secured form and receive I/O data in a secured form. In this manner, a single embodiment of the apparatus 206 may reside within the source module 208 and the destination module 210.

In one embodiment, the apparatus 206 includes a determination module 212 and a source security module 214. Optionally, the apparatus 206 may also include a source communication module 216. The determination module 212 identifies I/O data for transmission to the destination module 210 as secure I/O data. The destination module 210 is configured to receive and use the secure I/O data.

The determination module 212 may use a variety of techniques to identify I/O data that should be transmitted as secure I/O data, referred to herein as “sensitive I/O data.” Sensitive I/O data is typically data such as personal information or security information such as passwords and usernames. In one embodiment, the determination module 212 uses an con indicator associated with the I/O data to identify sensitive I/O data. Alternatively, the determination module 212 identifies sensitive I/O data based on the source of the data. For example, data from a particular memory chip or portion of memory may be designated as sensitive I/O data regardless of the content. Advantageously, the determination module 212 is selective about the I/O data that is secured such that hardware and software resources used in securing the I/O data are used most efficiently.

In addition, in one embodiment, the selective nature of the determination module 212 may be controlled by a command. The command may be issued by, or originate from, a software module or a user using some form of an input device. The input device may comprise standard peripherals such as a keyboard, but may also include specialized devices such as a security keycard reader, a keybox, a fingerprint scanner, a button or switch, or the like. Based on the command, the determination module 212 may identify no I/O data as secure data, a portion of I/O data as secure data, or substantially all I/O data as secure data. In this manner, a user or software module may control just how much of the I/O data is protected by the apparatus 206.

The source security module 214 communicates with the determination module 212. The source security module 214 encrypts sensitive I/O data identified by the determination module 212 to generate secured I/O data. The source security module 214 may use one or more encryption algorithms to encrypt the sensitive I/O data. The encryption algorithms may be symmetric or asymmetric. Depending on the encryption algorithm used, the destination module 210 uses the same encryption algorithm or can identify the encryption algorithm used from the secured I/O. The source security module 214 applies encryption and uses appropriate encryption keys such that the destination module 210 can decrypt the secured I/O data. Preferably, the secured I/O data is available exclusively to the destination module 210.

In certain embodiments, the apparatus 206 includes a source communication module 216. The source communication module 216 communicates the secure I/O data over the vulnerable communication link 202 to the destination module 210. In one embodiment, the source communication module 216 is specially configured to prevent tampering and to transmit secure I/O data. The destination module 210 receives and unencrypts the secure I/O data for a destination device 218. Preferably, the destination device 218 comprises a peripheral device.

Alternatively, the source communication module 216 may comprise a conventional communication module such as a blade-architecture driver and a network communication module. The blade-architecture driver may convert conventional I/O data from the blade into a format suitable for transmission over the network 204. The a network communication module may then ensure that the I/O data is transmitted properly over the network 204 to the proper destination module 210. In such an embodiment, the apparatus 206 may comprise solely the determination module 212 and the source security module 214. Consequently, in certain embodiments, the apparatus 206 may operate on I/O data entering the source communication module 216 (also referred to as an I/O communication module) as illustrated in FIG. 2. Alternatively, the apparatus 206 may operate on I/O data exiting the I/O communication module 216. In such an alternative embodiment, the I/O data encrypted by the apparatus 206 may be organized into network packets by the I/O communication module 216.

In this manner, the secure I/O data travels over the vulnerable communication link 202 in a protected format. If the secure I/O data is intercepted by an interceptor (See FIG. 1) “listening” on the network 204, the I/O data remains protected. Those of skill in the art recognize that the network 204 may comprise a plurality of routers, hubs, intermediate computers, other connected users, servers and the like. Each of the devices and/or software used to implement the network 204 may comprise a message intercept vulnerability. However, with the I/O data secured, intercepted I/O data is meaningless and useless to an interceptor.

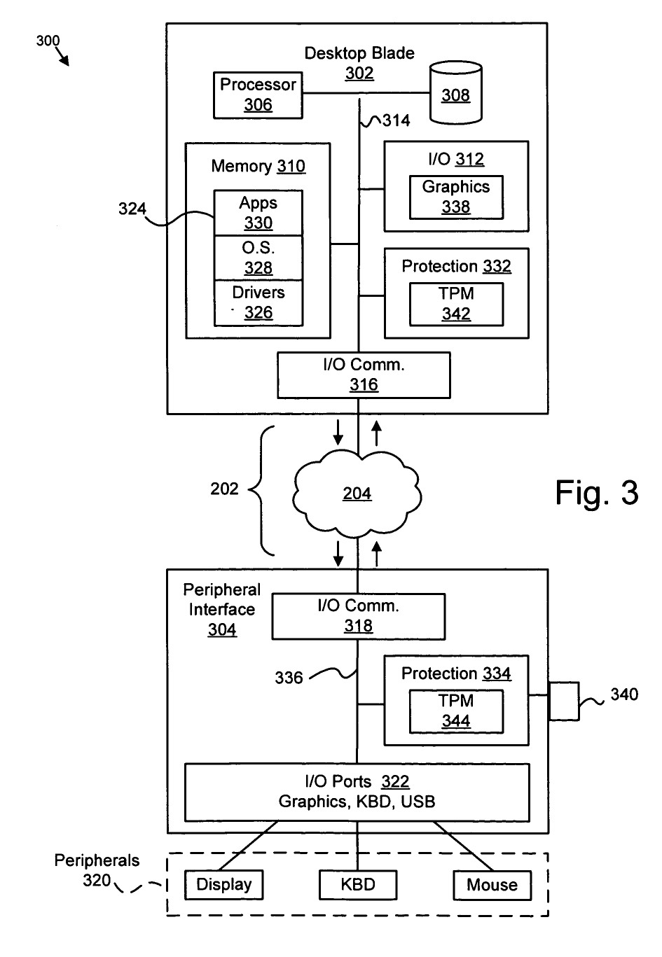

FIG. 3 illustrates a system 300 configured to secure I/O communications between a blade 302 and a peripheral interface device 304 of a blade-based computer system 300. The blade 302 may include conventional computer components including a processor 306, storage device 308, memory 310, and I/O adapters 312 connected using a bus 314. These are well known to those of skill in the art, consequently further description of these components will not be included. Because the blade 302 includes major components found in a desktop computer system, the blade 302 may also be referred to as a desktop blade 302.

In accordance with a blade-based architecture, the blade 302 includes an I/O communication module 316. The I/O communication module 316 exchanges I/O data with a corresponding I/O communication module 318 of a particular peripheral interface device 304. Preferably, the I/O communication modules 316, 318 are configured to send and receive I/O data. The I/O communication modules 316, 318 convert I/O data from standard I/O signals configured for use with a peripheral device 320 to messages suitable for transport across the network 204. Likewise, the I/O communication modules 316, 318 convert network messages to standard I/O signals configured for use with a peripheral device 320. In this manner, conventional I/O peripherals 320 such as displays/monitors, keyboards, mice, and the like can be used with conventional components and software modules 324 of the desktop blade 302. Preferably, the conventional I/O peripherals 320 connect to the peripheral interface device 304 using conventional I/O ports 322 to present I/O data to and receive I/O data from the user.

In one embodiment, the I/O communication modules 316, 318 comprise conventional network interface cards configured to convert I/O data into packets suitable for transmission over the network 204. The network 204 may comprise a packetized network the implements various networking protocols including Transport Control Protocol/Internet Protocol (TCP/IP), token ring, or the like. Consequently, implementing a blade-based architecture in certain embodiments may permit most components and software 324 used in desktop systems to remain largely unchanged with modifications being made to the I/O device drivers 326 for interacting with the I/O communication module 316.

Preferably, the software 324 typically includes I/O device drivers 326, an operating system 328, and a variety of applications 330. Such software components are well known to those of skill in the art and will not be described in detail. In one embodiment, the operating system 328 and applications 330 are configured to operate as though the system 300 is a conventional personal computer architecture. Alternatively, the operating system 328 and applications 330 may be configured to implement a more secure computer system such as those described in the Trusted Computing Platform Alliance (TCPA) PC Specific Implementation Specification. For example, the operating system 328 may comprise a secure operating system 328 configured to operate with certain hardware, firmware, and software components to ensure that the system 300 is free from compromise by malicious hardware or software.

The system 300 further includes a first protection module 332 and a corresponding second protection module 334. The first protection module 332 selectively encrypts I/O data transmitted over the vulnerable communication link 202 and decrypts I/O data received from the vulnerable communication link 202. The second protection module 334 provides the same functionality as the first protection module 332 to transmit secure I/O data to the first protection module 332. Preferably, the first protection module 332 is housed within the desktop blade 302 and connects to the bus 314. The peripheral interface device 304 may house the second protection module 334. A bus 336 may couple the second protection module 334, I/O communication module 318, and I/O ports 322.

Preferably, the first protection module 332 monitors the I/O data entering and exiting the I/O communication module 316. The second protection module 332 monitors the I/O data entering and exiting the I/O communication module 318. The I/O data may comprise raw video data, compressed video data, keystroke data, non-keyed user input data, and the like. The protection modules 332, 334 preferably distinguish between portions of the I/O data to identify I/O data that should be secured.

Those of skill in the art will recognize a variety of ways to direct the protection modules 332,334 regarding which portions of I/O data to encrypt and decrypt. In one embodiment, the I/O data includes an indicator that identifies the I/O data as data that the protection modules 332, 334 should encrypt/decrypt. Alternatively, the software 324 may signal the protection modules 332, 334 to encrypt/decrypt I/O data from particular sources. For example, the software 324 may send a command to the protection module 332 to encrypt all or a portion of the video I/O data either in memory 310 or coming directly from a graphics subsystem 338 such as a graphics card.

In another embodiment, a button or switch 340 connected to the second protection module 334 and extending from the peripheral interface device 304. The switch 340 may be a hardware switch or a logical switch implemented in the software 324. The switch 340 may cause the protection devices 332, 334 to protect one-way transmissions of I/O data, for example, inputs from the peripherals 320 such as keystrokes may be protected where output I/O data such as display data may not be protected. Alternatively, the switch 340 may cause the protection devices 332, 334 to protect substantially all two-way transmissions of I/O data such as both keystrokes and output display data. These transmissions may be protected for a limited period of time or until the switch 340 is deactivated.

In yet another embodiment, the protection modules 332, 334 may be even more selective about which I/O data is secured. For example, certain types of I/O data may be protected or I/O data from select portions of memory 310 may be protected based on a command. Preferably, the commands provide sufficient distinction and identification among parts of I/O data that a plurality of different levels of I/O data may be determined by the protection modules 332, 334 as secure data.

Typically, encryption and decryption operations are a computationally intensive. Furthermore, if encryption and decryption operations are performed using a central processor 306 and/or main memory 310, the system may not be able to provide assurances that the operations are not being compromised by rogue software or devices. Consequently, in certain embodiments, the protections modules 332, 334 include a Trusted Platform Module (TPM) 342, 344.

Preferably, a TPM 342,344 is a hardware component configured to encrypt or decrypt input data as needed. The TPM 342, 344 may support symmetric key algorithms which use the same key to encrypt and decrypt data. Examples of symmetric key algorithms include Advanced Encryption Standard (AES), Triple Data Encryption Standard (Triple-DES), and the like. The TPM 342,344 may support asymmetric key algorithms which use a first key, often private, to encrypt and a second key, often public, to decrypt the data. Examples of asymmetric key algorithms include Rivest, Shamir, Adleman (RSA), Diffie-Hellman, and the like. The I/O data may include the public key.

In one embodiment, for a given communication session such as a login session between the blade 302 and peripheral interface device 304 a single symmetric key is encrypted/decrypted using asymmetric keys such that a one-to-one relationship exists between a particular blade 302 and a particular peripheral interface device 304 yet the performance benefits of asymmetric keys are utilized. The single symmetric key may then be used to encrypt/decrypt the I/O data during the communication session. Of course those of skill in the art will recognize a variety of techniques more complex and/or more simple than those described herein. All such techniques are considered within the scope of the present invention.

Preferably, as hardware components the TPMs 342, 344 provide computationally intensive encryption/decryption services very quickly. In addition, the TPMs 342, 344 are configured to implement the TCPA PC Specific Implementation Specification such that the TPMs 342, 344 do not initialize into a secure state unless the TPM 342, 344 and associated components such as the protection modules 332, 334 are free from tampering and/or malicious code. Preferably, the TCPA PC Specific Implementation Specification sets forth a set of procedures and checks the TPMs 342, 344 will perform during a power on self test (POST) diagnostic procedure executed once power is provided to the TPM 342, 344.

If the POST procedure finds all the keys, binding, and configuration as expected, the TPMs 342, 344 will indicate that the TPM 342, 344 is in a secure state. A secure state is a state of operation free from tampering and/or software code that threatens the security of communications between the TPMs 342, 344. If the TPMs 342, 344 fail to initialize into a secure state, the TPMs 342,344 in one embodiment may fail to function and no I/O data is passed over the vulnerable communication link 202. Alternatively, I/O data may be passed but either of the TPMs 342, 344 may signal an error or unsecure condition.

The vulnerable communication link 202 may take a variety of forms depending on the type of connection between the blade 302 and the peripheral interface device 304. Where a network 204 is used the vulnerable communication link 202 may be wired or wireless and include a variety of intermediate components that present a message intercept vulnerability. Alternatively, the vulnerable communication link 202 may comprise a wired connection of a length sufficient to separate the blade 302 and the peripheral interface device 304 by a distance that introduces a message intercept vulnerability. For example, a wired connection between the blade 302 and the peripheral interface device 304 of a length up to about three feet can be readily inspected and reviewed by a user such that any foreign “listening” devices can be easily detected.

However, lengths greater than about three feet permit the blade 302 and the peripheral interface device 304 to be separated by a distance greater than about three feet such that foreign “listening” devices are not as easily detectable. Consequently, the distance between the blade 302 and the peripheral interface device 304 may introduce a message intercept vulnerability. For example, the blade 302 may reside in a different room than the peripheral interface device 304. Alternatively, the wire connecting the blade 302 and the peripheral interface device 304 may travel through a concealed space that presents a message intercept vulnerability.

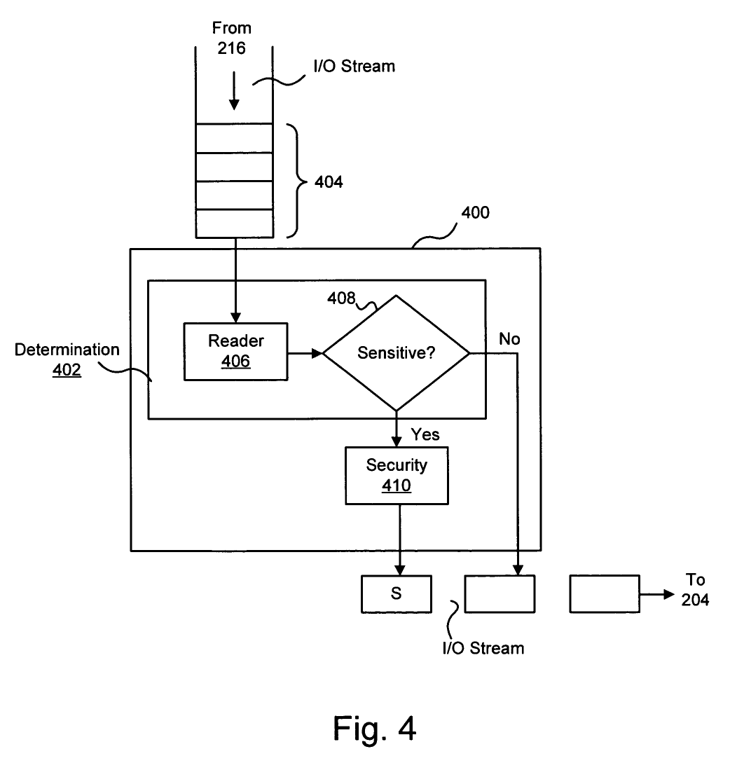

FIG. 4 illustrates one embodiment of a protection module 400 having a determination module 402 configured to selectively identify I/O data to be secured. The protection module 400 performs substantially the same functionality as the apparatus 206 described in relation to FIG. 2 and/or the protection modules 332,334 described in relation to FIG. 3. However, the protection module 400 may operate on the I/O data after the I/O data leaves the communication module 216, 316 of a source 208 and before the I/O data enters a destination module 210 or communication module 318.

In certain embodiments, the communication module 216 organizes the I/O data into a plurality of packets 404. The packets 404 may include a data section and a header/footer that includes identifying information as well as addressing information indicating the source and destination for the each packet 404.

Preferably, the determination module 402 functions in substantially the same manner as the determination module 212 described above in relation to FIG. 2. FIG. 4 illustrates the selection process in more detail. The determination module 402 may include a reader 406 configured to examine each packet 404. The reader 406 may read an identifier associated with each packet 404. The identifier may comprise a field in the header, footer, or body of the packet 404. Preferably, the I/O data is contained in the body of the packet 404. The identifier includes a value representative of a classification of the I/O data as either secure or unsecure. For example, an identifier of “S” may indicate the I/O data should be secured. A non-“S” identifier may indicate that the I/O data is not to be secured. Of course various other kinds of identifiers may be used in different embodiments.

In one embodiment, the identifier is set by the software 324 in response to a programmatic or user input command. Alternatively, certain I/O data may be configured to always include the identifier. For example, certain portions of raw video data originating from video memory (RAM) in a blade 302 may be designated as secure and therefore always include a secure data identifier.

The reader 406 reads the identifier from each packet 404 and provides the identifier to conditional logic 408. The conditional logic 408 compares the identifier to an expected identifier such as “S.” If the identifier in the packet 404 matches the expected identifier such as “S,” the conditional logic 408 signals a security module 410 to encrypt or decrypt the I/O data, as appropriate. If the identifier in the packet 404 does not match the expected identifier such as “S,” the packet 404 is unchanged. The conditional logic 408 puts the unchanged packet 404 back in the I/O stream that is sent to the network 204. Alternatively, within a peripheral interface device 304, the conditional logic 408 puts the unchanged packet 404 back in the I/O stream that is sent to the I/O communication module 318. Once the security module 410 encrypts or decrypts the I/O data, the packet 404 is also put back in the I/O stream that is sent to the network 204 or I/O communication module 318.

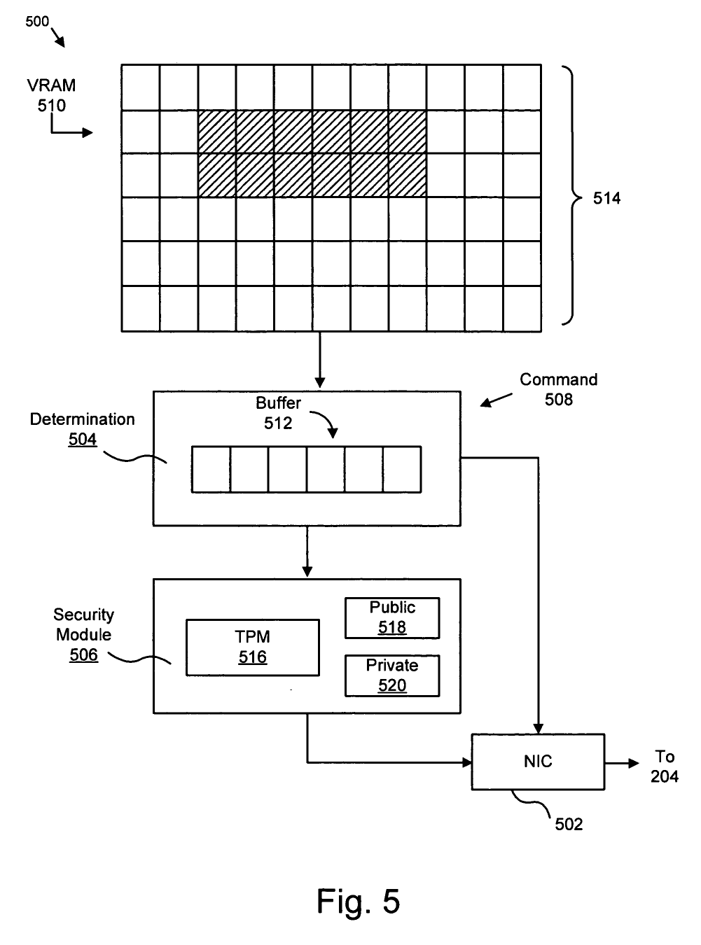

FIG. 5 illustrates one embodiment of an apparatus 500 in which I/O communications are secured prior to packetizing the I/O data using a communication module 502 such as a network interface card (NIC). The apparatus 500 may be configured to secure a particular type of I/O data such as sensitive video data.

The apparatus 500 may include a determination module 504 and a security module 506. The determination module 504 may operate in response to a command 508. The command 508 may originate from a software module, secure operating system, a hardware switch, or the like.

If no command 508 is provided, the determination module 504 simply moves video data from the video RAM (VRAM) 510, to an intermediate buffer 512 and then to the NIC 502. Typically, a video subsystem rapidly reads through the VRAM and sends the video data to the display device which displays the image. One complete sweep of the VRAM may comprise a single frame displayed on the entire display area of the display device. In certain embodiments, the determination module 504 may encrypt all the video data of a particular frame. Once all video data in VRAM has been sent, the video subsystem begins again at the beginning of the VRAM reading and displaying data.

If a command 508 is provided, a video subsystem having the determination module 504 may send all or a portion of the video data 514 through the security module 506 based on the command 508. In one embodiment, the command 508 defines a range of VRAM memory addresses that are to be secured. Consequently, as video data 514 within that range is placed in the buffer 512, the determination module 504 sends that video data, in the buffer 512, through the security module 506.

The range may be computed by a software driver 326, secure operating system 328, or an application 330 (See FIG. 3). Alternatively, a plurality of commands may be provided which each reference a different section of VRAM 510. In one embodiment, the secure operating system 328 may store sensitive video data in protected memory separate from general VRAM. Consequently, the determination module 504 may locate the sensitive video data in response to the command 508 and read the video data from the protected memory location.

In one embodiment, video data is defined by a Graphic User Interface (GUT) component defined by an application 330 or a secure operating system 328. The GUI component may comprise a special type of GUI component configured to protect I/O data input and/or output using the GUI component. Examples of a GUI component may include a login window, a window, a password text box, a username text box, an edit box, or the like. Preferably, the secure operating system 328 is configured to generate and display the GUI component such that the GUI component can not be obscured on a display device by another GUI component, window, or the like. In one embodiment, the secure operating system 328 converts the GUI component to a range of sensitive video data within the VRAM. The secure operating system 328 may also issue a command to the determination module 504 to protect video data in that range (illustrated by the shaded memory cells). The range represents a series of video pixels that the determination module 504 will encrypt to protect the video pixels over the vulnerable communication link 202.

The security module 506 encrypts the video data using a TPM 516, in one embodiment, similar to those described above. In the illustrated embodiment, the security module 506 may include a public key 518 and a private key 520. The security module 506 may use the public key 518 and a private key 520 in cooperation with a destination module to implement a Public Key encryption Infrastructure (PKI). PKI is a well known encryption architecture and further details of PKI will not be provided.

The security module 506 encrypts the appropriate portion of the buffer 512 based on the command 508. The security module 506 may also add an identifier identifying the video data as secured video data such that a second security module at a destination device can identify the secured video data and properly decrypt the video data sending the video data to a display device. Of course those of skill in the art will recognize that the determination module 504 may include suitable Digital to Analog Converters (DAC) or Digital Visual Interface (DVI) adapters are appropriate convert the video data.

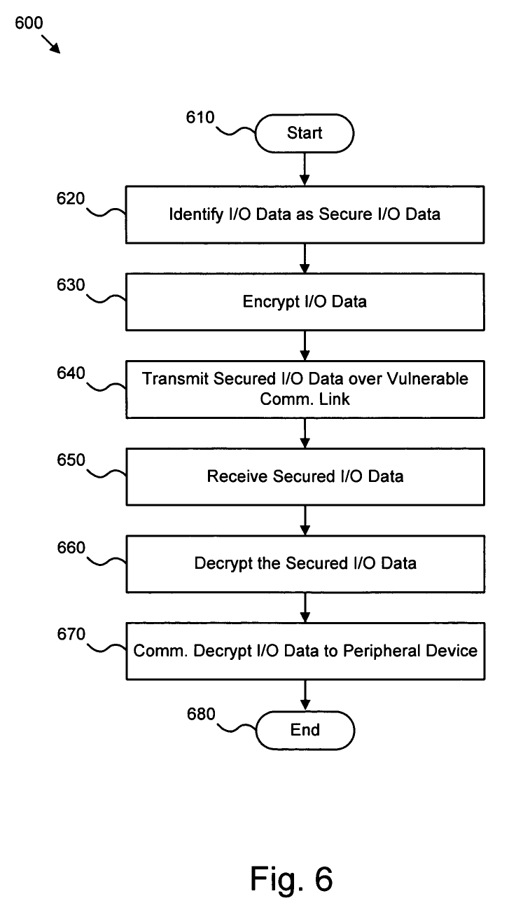

FIG. 6 illustrates a method 600 for securing I/O communications between a peripheral interface device and a blade of a blade-based computer system. In particular, the method 600 secures I/O data transmitted across a vulnerable communication link susceptible to interception of transmitted messages. In certain embodiments, the method 600 operates on raw video data sent from a video memory device 510 of the blade 302 to a peripheral interface device 304 over the vulnerable communication link 202. The method 600 may be embodied as a set of machine-readable instructions.

The method 600 begins 610 when a command 508 is issued to protect specific I/O data and/or initiate a secure I/O communication channel. The command 508 may come from user input or an instruction in a software module. The command 508 may specifically designate that all subsequent I/O data communication is to be using secure I/O data. Alternatively, the command 508 may require more selectivity for I/O data.

Initially, in one embodiment, a determination module 212 identifies 620 I/O data as secure I/O data. The I/O data is configured for transmission between the blade 302 and the peripheral interface device 304. In certain embodiment, the I/O data to be secured is identified by an identifier. Alternatively, the storage location of the I/O data may sufficiently identify the I/O data as secure I/O data. Next, a security module 214 may encrypt 630 the I/O data such that a particular peripheral interface device 304 can decrypt the I/O data. A communication module 216 then transmits 640 the secured I/O data such as video data over a vulnerable communication link 202. Preferably, the vulnerable communication link 202 comprises a typical communication link used in blade-based computer systems.

A destination device receives 650 the secured I/O data using for example an I/O communication module 318. Alternatively, the destination device 650 may comprise the blade 302. A second protection module 334 may decrypt 660 the secured I/O data using an encryption key stored on the destination device. The encryption key may comprise a private symmetric key or an asymmetric key. Once decrypted, the second protection module 334 or a control module may route the decrypted I/O data to an appropriate port 322 for presentation by a peripheral device 320, and the method 600 ends 608. Alternatively, the I/O data such as keystrokes may be routed to a blade processor 306, and the method 600 ends 608. The method 600 may also end in response to a new command 508 halting securing of I/O data.

The present invention prevents a “man-in-the-middle” attack by securing I/O data passing over a communication link in a blade-based computer system. The I/O communications are secure between a blade and a peripheral interface device. Beneficially, the apparatus, system, and method operate at high speed and selectively protect just the sensitive I/O data. The apparatus, system, and method protect both outgoing and incoming streams of I/O data as well as permit securing of I/O data to be controlled programmatically and/or based on user input.

Many of the functional units described in this specification have been labeled as components, in order to more particularly emphasize their implementation independence. For example, a component may be implemented as a hardware circuit comprising custom VLSI circuits or gate arrays, off-the-shelf semiconductors such as logic chips, transistors, or other discrete components. A component may also be implemented in programmable cat hardware devices such as field programmable gate arrays, programmable array logic, programmable logic devices or the like.

Components may also be implemented in software for execution by various types of processors. An identified component of executable code may, for instance, comprise one or more physical or logical blocks of computer instructions which may, for instance, be organized as an object, procedure, or function. Nevertheless, the executables of an identified component need not be physically located together, but may comprise disparate instructions stored in different locations which, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software components, user selections, network transactions, database queries, database structures, hardware components, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for securing input/output (I/O) communications between a peripheral interface device and a blade of a blade-based computer system, the apparatus comprising:
a determination module configured to identify I/O data configured for transmission to a destination module configured to receive secure I/O data;
a source security module coupled to the determination module and configured to encrypt the I/O data to generate secured I/O data such that subsequent decryption of the secured I/O data is restricted to the destination module; and
a source communication module configured to transmit the secured I/O data over a vulnerable communication link to the destination module, the vulnerable communication link comprising a message intercept vulnerability and the destination module configured to unencrypt the secure I/O data for a destination device.

2. The apparatus of claim 1, wherein the determination module is further configured to selectively identify substantially all I/O data, a portion of I/O data, and no I/O data as secure I/O data in response to a command.

3. The apparatus of claim 2 wherein the command is issued by one of a user and a software module.

4. The apparatus of claim 1, wherein the I/O data is selected from the group of I/O data consisting of raw video data, compressed video data, keystroke data, and non-keyed user input data.

5. The apparatus of claim 1, wherein the determination module comprises a reader configured to read an identifier associated with the I/O data, the identifier classifying the I/O data as secure I/O data.

6. The apparatus of claim 1, wherein the source security module comprises a source Trusted Platform Module (TPM) configured to encrypt the I/O data in response to the source TPM initializing into a secure state and wherein the destination module comprises a destination Trusted Platform Module (TPM), the destination TPM configured to decrypt the I/O data in response to the destination TPM initializing into a secure state.

7. The apparatus of claim 1, wherein the vulnerable communication link comprises messages passing over a packetized network.

8. A system for securing Input/Output (I/O) communications between a peripheral interface device and a blade of a blade-based computer system, the system comprising:
a desktop blade comprising an I/O communication module configured to exchange I/O data with a user;
at least one peripheral device remote from the desktop blade and configured to directly present I/O data to and receive I/O data from the user;
a peripheral interface device in electrical communication with the at least one peripheral device and configured to receive I/O data from the I/O communication module over a vulnerable communication link having a message intercept vulnerability; and
a first protection module configured to selectively encrypt I/O data transmitted over the vulnerable communication link and decrypt I/O data received from the vulnerable communication link.

9. The system of claim 8, wherein the desktop blade comprises the first protection module and the peripheral interface device comprises a second protection module corresponding to the first protection module.

10. The system of claim 9, wherein the first security module and second security module each comprise a Trusted Platform Module (TPM) configured to encrypt unencrypted I/O data and decrypt encrypted I/O data in response to initializing the TPM into a secure state.

11. The system of claim 8, wherein the first security module is further configured to selectively identify substantially all I/O data and a portion of I/O data in response to a command, the command originating from one of a user and a software module.

12. The system of claim 8, wherein the first security module operates on I/O data exiting the I/O communication module, the I/O data organized into network packets.

13. The system of claim 8, wherein the first security module operates on I/O data entering the I/O communication module.

14. A method for securing Input/Output (I/O) communications between a peripheral interface device and a blade of a blade-based computer system, the method comprising:
identifying I/O data configured for transmission between the peripheral interface device and the blade as secure I/O data;
encrypting the I/O data such that subsequent decryption of the I/O data is limited to the peripheral interface device and the blade, the encrypted I/O data comprising secured I/O data; and
transmitting the secured I/O data over a vulnerable communication link between the peripheral interface device and the blade, the vulnerable communication link susceptible to interception of transmitted messages.

15. The method of claim 14, further comprising,
receiving the secured I/O data at a receiving device, the receiving device comprising one of the peripheral interface device and the blade;
decrypting the secured I/O data with a key stored exclusively with the receiving device; and
communicating the decrypted I/O data to one of a peripheral device and a blade processor.

16. The method of claim 14, wherein identifying I/O data comprises locating I/O data designated by a command that specifically designates communication of secure I/O data, the command issued in response to one of user input and an instruction in a software module.

17. The method of claim 14, wherein the peripheral device comprises a display device and the I/O data comprises raw video data originating from a video memory device of the blade, the I/O data addressed to the peripheral interface device.

18. The method of claim 14, wherein the vulnerable communication link comprises a wired connection of a length capable of separating the peripheral interface device and the blade by a distance greater than about three feet.

19. An apparatus for securing Input/Output (I/O) communications between a peripheral interface device and a blade of a blade-based computer system, the apparatus comprising:
a determination module configured to identify sensitive video data within video memory of a blade, the video memory configured for transmission to a display device;
a first security module configured to encrypt the sensitive video data to generate secured video data;
a communication module configured to transmit the secured video data over a vulnerable communication link connecting a peripheral interface device and the blade; and
wherein the peripheral interface device comprises a second security module configured to decrypt the secured video data and send the decrypted video data to a display device.

20. The apparatus of claim 19, wherein the sensitive video data is defined by a Graphic User Interface (GUI) component configured to display sensitive data, the apparatus further comprising a secure operating system configured to generates the GUI component such that the GUI component can not be obscured.

21. The apparatus of claim 19, wherein the sensitive video data comprises a complete frame of the display device.

22. The apparatus of claim 19, wherein the determination module identifies a series of video pixels as sensitive video data in response to a command from the user.

23. A signal bearing medium tangibly embodying a program of machine-readable instructions executable by a digital processing apparatus to perform operations to secure Input/Output (I/O) communications between a peripheral interface device and a blade of a blade-based computer system, the operations comprising:
an operation to identify I/O data configured for transmission between the peripheral interface device and the blade as secure I/O data;
an operation to encrypt the I/O data such that subsequent decryption of the I/O data is limited to the peripheral interface device and the blade, the encrypted I/O data comprising secured I/O data; and
an operation to transmit the secured I/O data over a vulnerable communication link between the peripheral interface device and the blade, the vulnerable communication link susceptible to interception of transmitted messages.

24. The signal bearing medium of claim 23, wherein the an operation to identify I/O data comprises locating I/O data designated by a command that specifically designates communication of secure I/O data, the command issued in response to one of user input and an instruction in a software module.

25. The signal bearing medium of claim 23, wherein the peripheral interface device is connected to a display device and the I/O data comprises raw video data originating from a video memory device of the blade, the I/O data addressed to the peripheral interface device.
